(19) United States
(12) Patent Application Publication
(10) Pub. No.: US 2015/0120868 A1
(43) Pub. Date: Apr. 30, 2015

(54) INFORMATION PROCESSING METHOD, INFORMATION PROCESSING DEVICE, AND STORAGE MEDIUM

(71) Applicant: FUJITSU LIMITED, Kawasaki-shi (JP)

(72) Inventors: Masaki FUJITA, Yokohama (JP); Toyoaki NAKAMOTO, Machida (JP)

(73) Assignee: FUJITSU LIMITED, Kawasaki-shi (JP)

(21) Appl. No.: 14/519,247

(22) Filed: Oct. 21, 2014

(30) Foreign Application Priority Data
Oct. 31, 2013 (JP) 2013-227491

(51) Int. Cl. H04L 29/06

(52) U.S. Cl. CPC H04L 63/06
USPC 709/217

(57) ABSTRACT

An information processing method performed by a computer coupled to a plurality of terminal devices, the information processing method includes setting a first number representing the number of terminal devices belonging to a first subnet capable of simultaneously performing download processing of certain content, and a second number representing the number of terminal devices belonging to a second subnet capable of simultaneously performing the download processing; receiving a download request from the first terminal device; downloading target content indicated in the download request to the first terminal device, when the number of terminal devices belonging to the first subnet that are performing download processing of the target content is less than the first number; measuring a time used for downloading of the target content to the first terminal device; and updating the first number and the second number, based on a comparison of the time and a predetermined time.

### CROSS-REFERENCE TO RELATED APPLICATION

This application is based upon and claims the benefit of priority of the prior Japanese Patent Application No. 2013-227491, filed on Oct. 31, 2013, the entire contents of which are incorporated herein by reference.

### FIELD

The embodiment discussed herein is related to an information processing method, an information processing device, and a storage medium.

### BACKGROUND

These days, various kinds of content, such as programs and applets, are downloaded from web servers to client terminals, such as personal computers (PC), through networks. At such a time, the number of downloads has been controlled in consideration of loads imposed on a network.

For example, there has been proposed a technique in which a maximum number of programs that can be simultaneously downloadable, and one or more programs are simultaneously downloaded within a range where the maximum number is not exceeded. In this technique, reference is made to a corresponding relationship definition table in which the corresponding relationship between the network bandwidth and the number of downloads is defined. Then, the number of downloads corresponding to the measured band of the network is specified, and the specified number of downloads is set as the maximum number of programs that can be simultaneously downloadable. Japanese Laid-open Patent Publication No. 2011-107954 and so forth have been disclosed as examples of the related art.

Unfortunately, in the aforementioned related art, if a large amount of downloading is simultaneously performed to client terminals belonging to a small subnet having a small band, which is part of a network, it takes a long time to complete downloading. Accordingly, the number of downloads specified, as a maximum number of programs that can be simultaneously downloadable, from the correspondence relationship definition table is decreased. For this reason, limitations on downloading of content are applied even to client terminals belonging to another subnet having a sufficient band.

For example, in an intra-company network and so forth, there are some cases where, upon start of operations, almost all the client terminals simultaneously download the same content. If limitations on downloading as mention above are placed in such cases, a period of time taken until completion of downloading of all the client terminals might become longer, which, in turn, might delay the point in time when operations start.

### SUMMARY

According to an aspect of the invention, an information processing method performed by a computer coupled to a plurality of terminal devices belonging to a network divided into a plurality of subnets including at least a first subnet and a second subnet, the plurality of terminal devices including at least a first terminal device belonging to the first subnet and a second terminal device belonging to the second subnet, the information processing method includes setting a first number in association with the first subnet and a second number in association with the second subnet, the first number representing the number of terminal devices capable of simultaneously performing download processing of certain content, among one or more terminal devices belonging to the first subnet, and the second number representing the number of terminal devices capable of simultaneously performing download processing of the certain content, among one or more terminal devices belonging to the second subnet; receiving a download request from the first terminal device; downloading target content indicated in the download request to the first terminal device, when the number of terminal devices belonging to the first subnet that are performing download processing of the target content is less than the first number; measuring a time used for downloading related to the downloading of the target content to the first terminal device; and updating the first number and the second number, based on a comparison of the time measured by the measuring and a predetermined time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an information processing system;

FIG. 2 is a sequence diagram illustrating download of an applet;

FIG. 3 depicts an example of an HTML file in which the applet is embedded;

FIG. 4 depicts an example of an applet request to which a download date and time is added;

FIG. 5 is a schematic illustration for explaining problems when download control is exerted uniformly over a network;

FIG. 6 is a block diagram illustrating an example of a configuration of an information processing device according to this embodiment;

FIG. 7 is a schematic block diagram illustrating an example of a computer that functions as the information processing device;

FIG. 8 is a flowchart illustrating a setting process;

FIG. 9 is a block diagram illustrating an example of a network configuration;

FIG. 10 depicts an example of a network configuration table;

FIG. 11 depicts an example of a target time management table;

FIG. 12 depicts an example of a download management table;

FIG. 13 is a flowchart illustrating a determination process;

FIG. 14 is a flowchart illustrating an adjustment process;

FIG. 15 depicts an example of a download management table in a comparative example;

FIG. 16 depicts an example of a target time management table in the comparative example;

FIG. 17 is a table illustrating an example of download results in the comparative example;

FIG. 18 is a table illustrating another example of download results in the comparative example;

FIG. 19 is a table illustrating an example of download results in this embodiment;

FIG. 20 is a table illustrating another example of download results in this embodiment; and

FIG. 21 is a schematic illustration depicting effects of this embodiment.

### DESCRIPTION OF EMBODIMENT

Hereinafter, an example of an embodiment related to the techniques of this disclosure will be described with reference to the accompanying drawings.

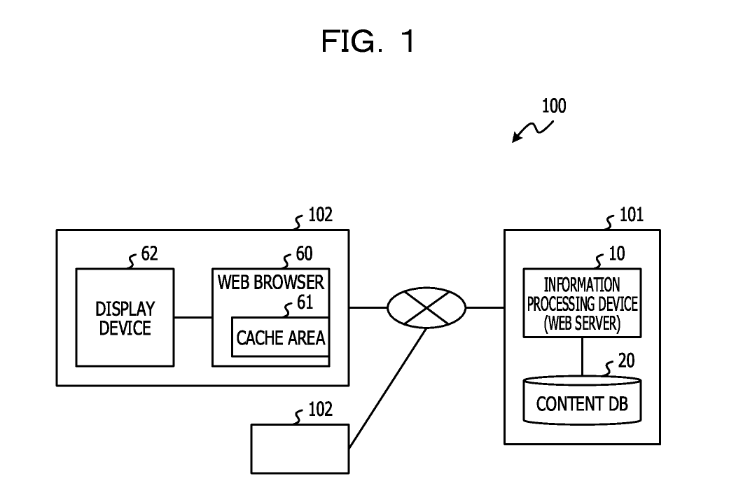

As illustrated in FIG. 1, an information processing device 10 according to this embodiment is a web server in a server 101 included, together with client terminals 102, in an information processing system 100. The server 101 and the plurality of client terminals 102 are connected over the Internet and the like to form one network. The network made up of the server 101 and the client terminals 102 is divided into a plurality of subnets. Each of the client terminals 102 belongs to a corresponding one of the subnets.

The server 101 includes the information processing device 10 and a content database (DB) 20 in which a plurality of HTML files and a plurality of applets are stored. Each of the client terminal 102 is a terminal, such as a personal computer (PC) or a smartphone. A web browser 60 is installed in the client terminal 102. The client terminal 102 includes a display device 62 for displaying content acquired through the web browser 60.

In the information processing system 100, the client terminal 102 requests the server 101 to download content. Then, the server 101 transfers the requested content to the client terminal 102. In the information processing device 10, the number of downloads at the time when the same content is simultaneously downloaded is controlled. In this embodiment, the case where content for which simultaneous downloading is to be controlled is assumed to be an applet will be described. An applet is a Java (registered trademark) program that runs in a web browser.

Here, download of an applet is described before details of the information processing device 10 according to this embodiment are described.

When the client terminal 102 displays a web page indicated by an HTML file in which the applet is embedded, by using the web browser 60, an applet is downloaded from the information processing device 10 to the client terminal 102.

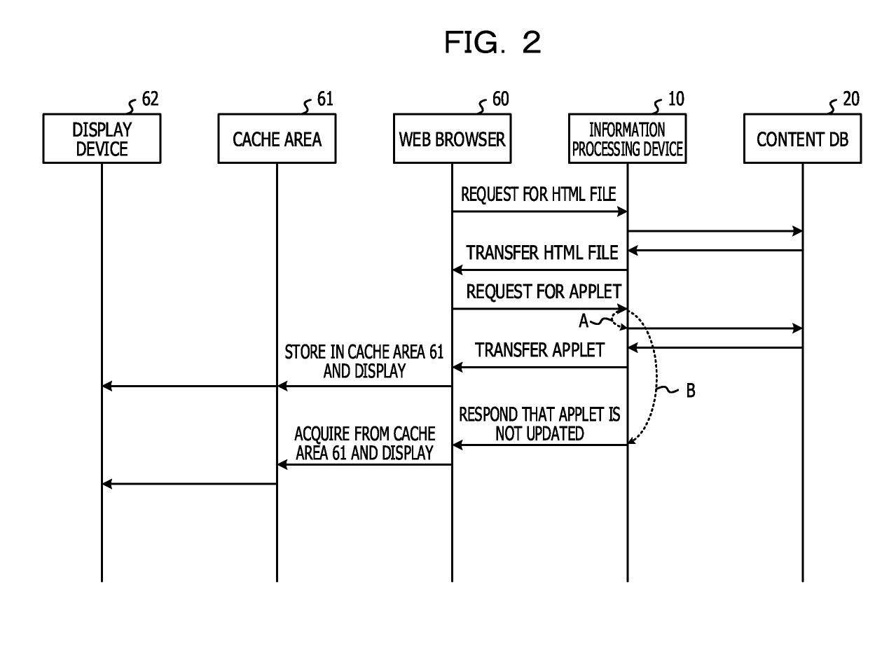

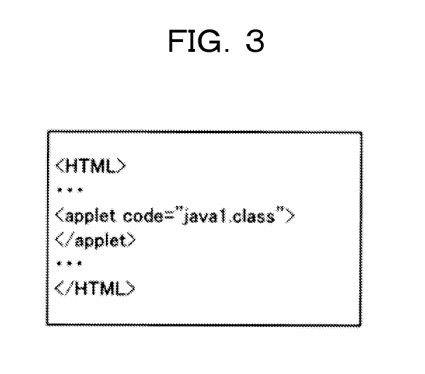

In particular, as illustrated in FIG. 2, when a request for an HTML file is sent from the Web browser 60 to the information processing device 10, the information processing device 10 acquires a corresponding HTML file from the content DB 20, and transfers the acquired file to the Web browser 60. If an applet is embedded, for example, as depicted in FIG. 3, in this HTML file, a request for an applet is sent from the web browser 60 to the information processing device 10.

Here, upon being downloaded to the client terminal 102, the applet is temporarily cached in a cache area 61 in the web browser 60. For this reason, when displaying a web page indicated by an HTML file in which the same applet as the cached applet is embedded, by using the web browser 60, the client terminal 102 does not perform download of the same applet and may use the applet in the cache area 61. However, if, although an applet to be displayed is the same applet as the cached applet, the cached applet has been updated after its download to the client terminal 102, the applet to be displayed has to be downloaded again.

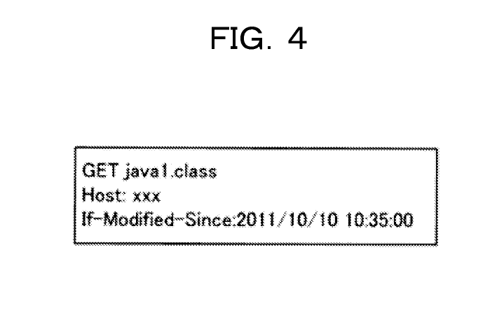

Accordingly, the web browser 60 sends an applet request to which information for determining whether the applet has been updated is added, to the information processing device 10. For example, as illustrated in FIG. 4, the download date and time when an applet is downloaded to the client terminal 102, that is, the date and time when the applet is cached in the cache area 61 is set in an IF-Modified-Since field of an HTTP header. Then, the applet request with the download date and time in the IF-Modified-Since field is sent from the client terminal 102 to the information processing device 10.

In the information processing device 10, the download date and time of the applet set in the IF-Modified-Since field is compared with the date and time of an applet stored in the content DB 20. The update time of an applet is the update time of the latest version of an applet stored in the content DB 20.

If the update time of the applet stored in the content DB 20 is later, the information processing device 10 acquires a corresponding applet from the content OB 20 and transfers the acquired applet to the web browser 60 as indicated by a dotted-line arrow A in FIG. 2. The web browser 60 caches the applet transferred from the information processing device 10 in the cache area 61, and displays the applet on the display device 62. Otherwise, if the download date and time of the applet set in the IF-Modified-Since field is later, the information processing device 10 provides the web browser 60 with a response indicating that the applet stored in the content DB has not been updated, as indicated by a dotted-line arrow B in FIG. 2. The web browser 60 acquires an applet from the cache area 61, and displays the applet on the display device 62.

For example, it is assumed that, in the case where the client terminal 102 is used for an application purpose like a business-use PC, an applet is embedded in an HTML indicating a Web page to which employees simultaneously refer at the same time as the operations start. If the applet concerned has been updated at the time when the operations start, the applet is downloaded all at once. In this case, the band of a network serving as the path of downloading is narrowed, and, as a result, downloading takes a long time or results in failure. When downloading takes a long time, a user of the client terminal 102 becomes unbearable and becomes likely to stop processing or retry processing. As a result, the load on the network further increases.

In order to avoid such a problem, a measure, such as shifting the time of access to an HTML where an applet is embedded, has to be taken so that downloading of the applet is not performed all at once from the client terminals 102. An avoidance measure is a process in which a simultaneous download maximum number representing the maximum number of simultaneous downloads of the same applet is provided to limit the number of simultaneous downloads.

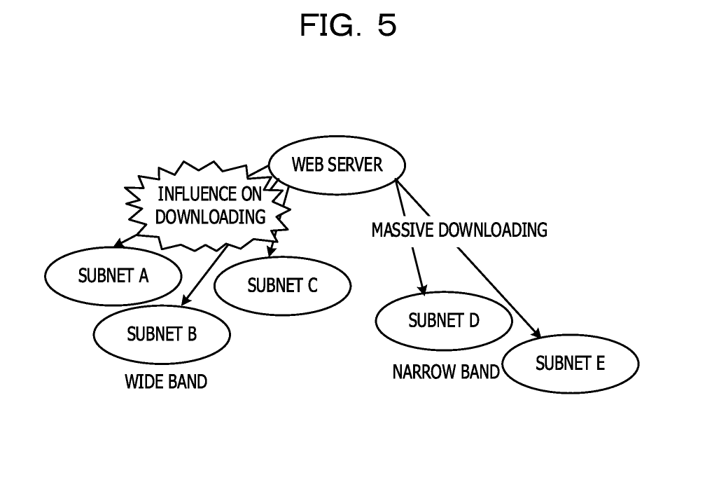

However, if a simultaneous download maximum number is set uniformly for a network as in the related art examples, it is impossible to efficiently reduce the load imposed on the entire network. For example, as illustrated in FIG. 5, if a large amount of downloading to client terminals belonging to a subnet having a narrow band is performed, it takes a long time to complete downloading, and the simultaneous download maximum number is reduced by performing a process for limiting simultaneous downloading. This exerts an influence on downloading at client terminals belonging to a wide-band subnet.

To address this, in the information processing device 10 according to this embodiment, suppression of network loads using the simultaneous download maximum number is controlled for every subnet on the side of the client terminals 102. Thus, the interference between subnets is avoided, and suppression of network loads is equalized among subnets. The information processing device 10 is described in more detail below.

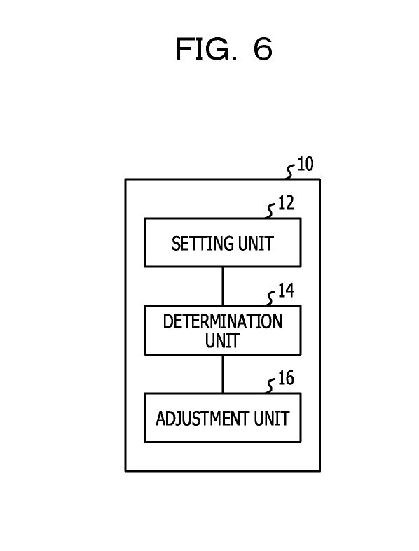

The information processing device 10 includes a setting unit 12, a determination unit 14, and an adjustment unit 16 as illustrated in FIG. 6.

The setting unit 12 calculates the initial value of the simultaneous download maximum number, which represents the maximum number of the client terminals 102 when content is simultaneously downloaded to the client terminals 102, for every subnet and for every applet, based on a network configuration. Then, the setting unit 12 sets the calculated initial value in a download management table.

When a download request for an applet is provided from the client terminal 102, the determination unit 14 determines whether the applet for which the download request is made is a download-limited applet. A download-limited applet is an applet that is not urgent in terms of being updated to the latest version and whose new and old versions may exist together if the applet is cached in the cache area 61 of each of the client terminals 102. That is, the download-limited applet is an applet that does not have to be transferred from the information processing device 10 immediately in response to a download request from the client terminal 102.

The determination unit 14 determines whether to allow downloading, if the applet for which a download request has been provided from the client terminal 102 is a download-limited applet. In particular, the determination unit 14 acquires a simultaneous download maximum number set for a subnet to which the client terminal 102 that has made a download request belongs and for the applet for which the download request has been provided. The determination unit 14 acquires the number of other client terminals 102 belonging to the same subnet as a subnet to which the client terminal 102 that has made the download request belongs, and currently performing download processing of the applet for which the download request has been provided. Then, the determination unit 14 determines that the applet is not to be downloaded, if the number of other client terminals 102 during download processing is equal to or greater than the simultaneous download maximum number. Otherwise, if the number of other client terminals 102 during download processing is less than the simultaneous download maximum number, it is determined that the applet is to be downloaded.

As mentioned above, the determination unit 14 determines whether the applet for which the download request has been provided is updated. Then, the determination unit 14 determines that the applet is to be downloaded, only if the applet for which the download request has been provided is updated.

If it is determined that the applet is to be downloaded, the determination unit 14 acquires the corresponding applet from the content DB 20 and transfers it to the client terminal 102. Otherwise, if it is determined that the applet is not to be downloaded, the determination unit 14 sends the client terminal 102 a notification that the applet is not to be transferred.

The adjustment unit 16 adjusts the simultaneous download maximum number for every applet and for every subnet, based on a time used when the applet has been downloaded to the client terminal 102. In particular, the adjustment unit 16 decreases the simultaneous download maximum number for the applet concerned and for a subnet including the client terminal 102 for which the time used for downloading the applet exceeds a predetermined condition. Then, the adjustment unit 16 increases each of the simultaneous download maximum numbers of other subnets for the applet concerned in accordance with the decrease. The simultaneous download maximum number for the applet concerned and for a subnet that does not include the client terminal 102 for which the time used for downloading the applet exceeds the predetermined condition is increased. The adjustment unit 16 also decreases each of the simultaneous download maximum numbers of other subnets for the applet concerned in accordance with the increase.

For every applet and for every subnet, if the number of client terminals that have not completed download processing is smaller than the simultaneous download maximum number, the adjustment unit 16 regards the number of client terminals that have not completed download processing as the simultaneous download maximum number for the applet concerned and for the subnet concerned. The adjustment unit 16 distributes the difference between the simultaneous download maximum number and the number of client terminals that have not completed download processing, to the simultaneous download maximum numbers of other subnets for the applet concerned.

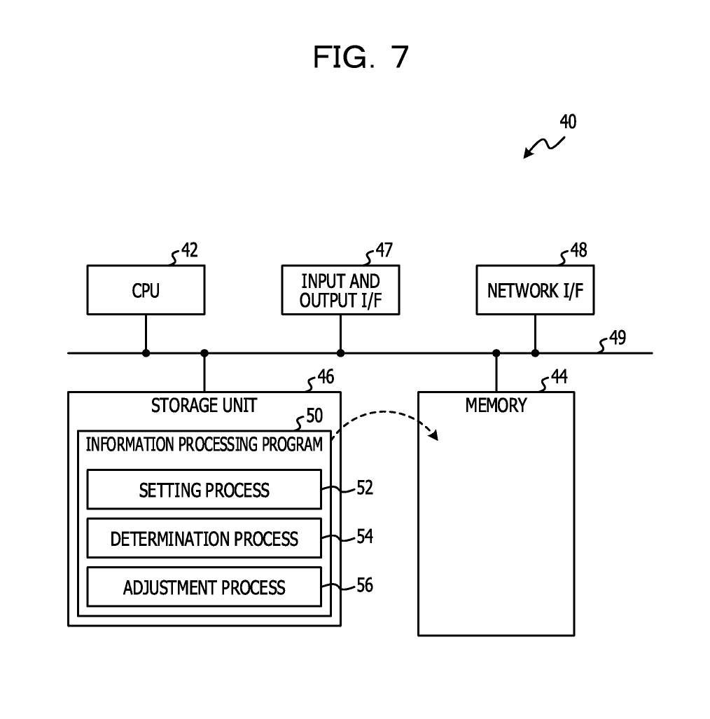

The information processing device 10 may be implemented, for example, by a computer 40 illustrated in FIG. 7. The computer 40 includes a central processing unit (CPU) 42, a memory 44, a nonvolatile storage unit 46, an input and output interface (I/F) 47, and a network I/F 48. The CPU 42, the memory 44, the storage unit 46, the input and output I/F 47, and the network I/F 48 are connected to one another through a bus 49.

The storage unit 46 may be implemented by a hard disk drive (HDD), a flash memory, or the like. In the storage unit 46 serving as a storage medium, an information processing program 50 for causing the computer 40 to function as the information processing unit 10 is stored. The CPU 42 reads the information processing program 50 from the storage unit 46, and develops this program in the memory 44. Then, the CPU 42 sequentially performs processes included in the information processing program 50.

The information processing program 50 includes a setting process 52, a determination process 54, and an adjustment process 56.

The CPU 42 operates as the setting unit 12 illustrated in FIG. 6 by performing the setting process 52. The CPU 42 operates as the determination unit 14 illustrated in FIG. 6 by performing the determining process 54. The CPU 42 operates as the adjustment unit 16 illustrated in FIG. 6 by performing the adjustment process 56. Thus, the computer 40 that executes the information processing program 50 functions as the information processing device 10.

The information processing device 10 may also be implemented, for example, by a semiconductor integrated circuit, more particularly, an application specification integrated circuit (ASIC) or the like.

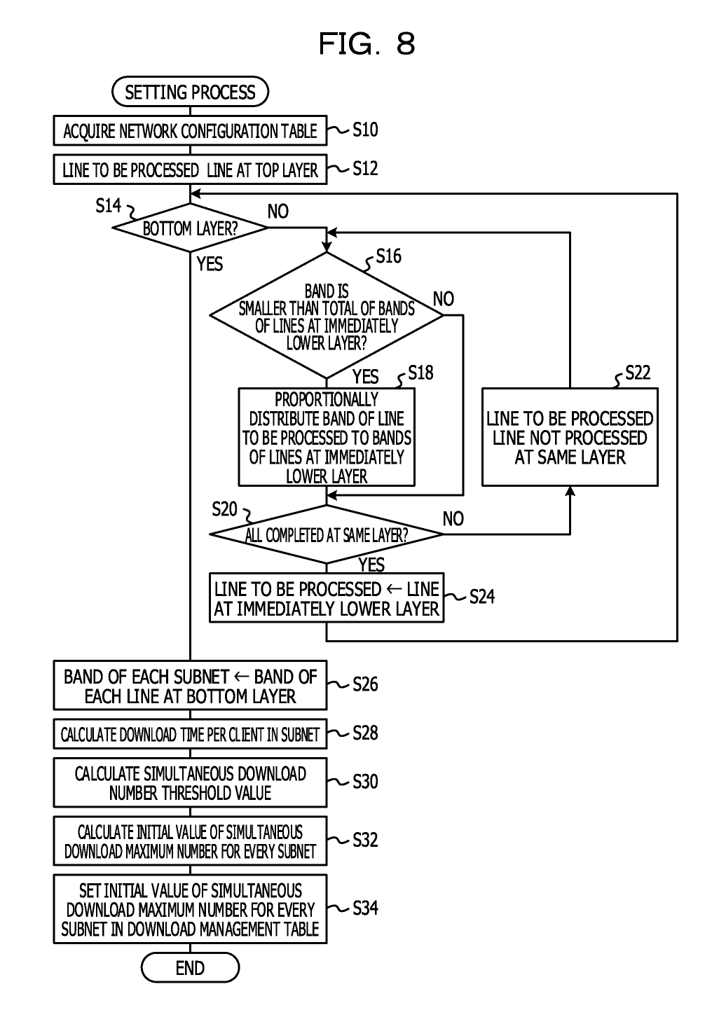

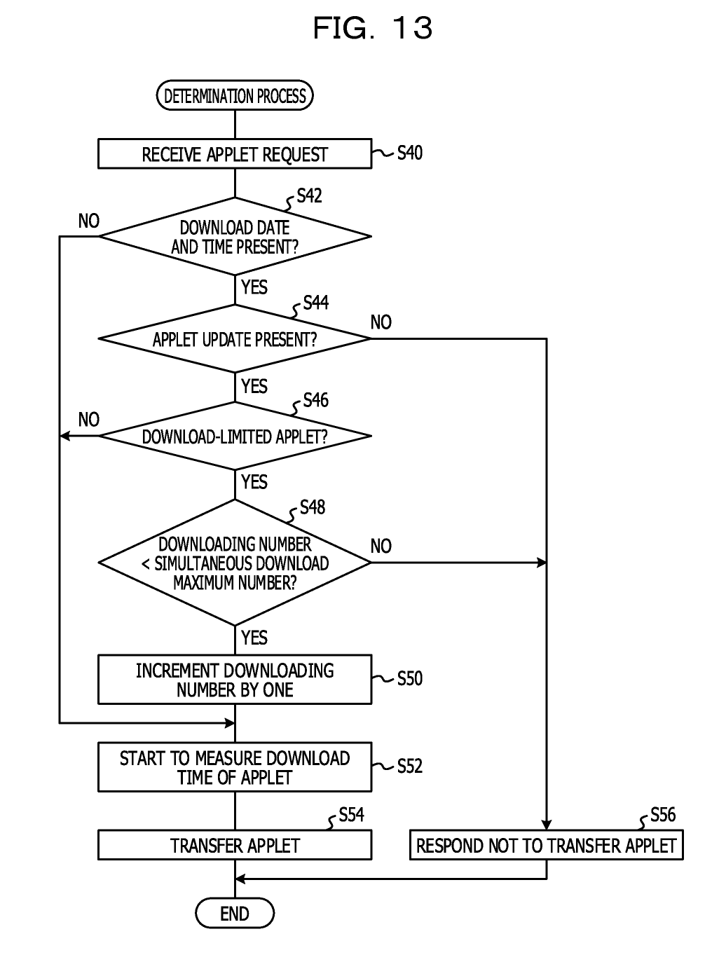

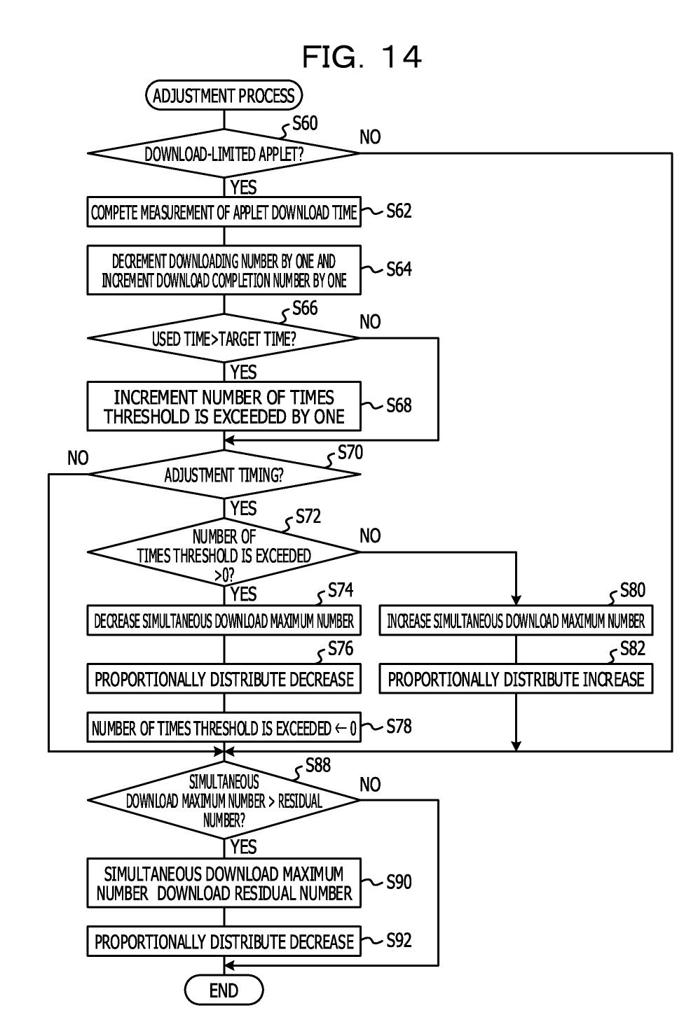

Next, operations of the information processing device 10 according to this embodiment will be described. First, in the information processing device 10, a setting process routine illustrated in FIG. 8 is performed to set the initial value of a simultaneous download maximum number for every applet and for every subnet. Each time a download request of an applet is sent from the client terminal 102, the determination process routine illustrated in FIG. 13 is performed to determine whether to allow downloading. In parallel with the determination process routine, an adjustment process routine illustrated in FIG. 14 is performed to adjust the simultaneous download maximum number for every applet and for every subnet. Each process will be described in detail below.

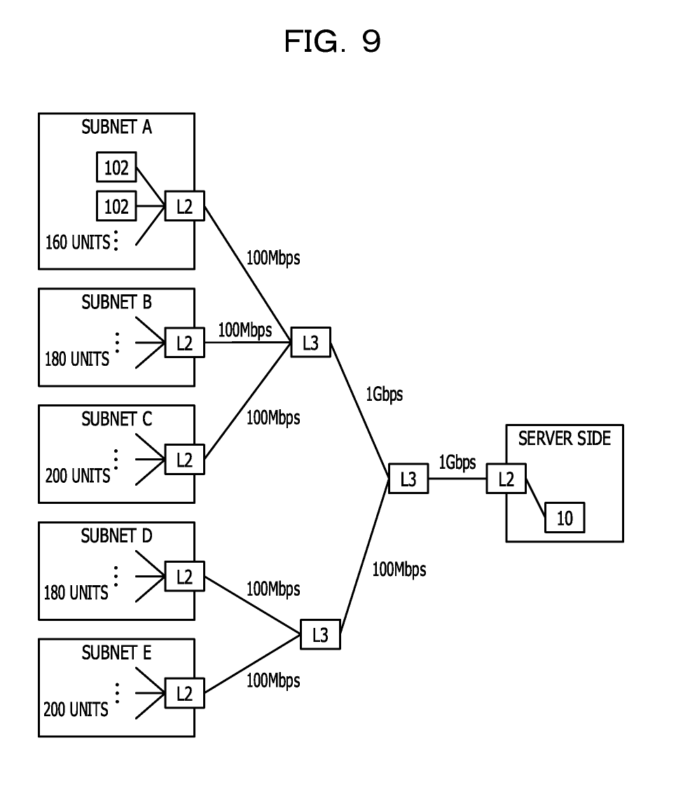

At S10 of the setting process routine illustrated in FIG. 8, the setting unit 12 acquires a network configuration table depicting the configuration of the entire network. The network configuration table registers at least the number of client terminals 102 belonging to each subnet, and the band of the line in each level between the client terminal 102 and the information processing device 10, and is stored in advance in a predetermined storage area. FIG. 9 illustrates an example of a configuration of the entire network. This network is divided into a subnet A, a subnet B, a subnet C, a subnet D, and a subnet E. Specifically, 160 client terminals 102 belong to the subnet A, 180 client terminals 102 belong to the subnet B, 200 client terminals 102 belong to the subnet C, 180 client terminals 102 belong to the subnet D, and 200 client terminals 102 belong to the subnet E.

In FIG. 9, L2 designates a layer 2 switch, which is a relay device of the data link layer. L3 designates a layer 3 switch, which is a relay device of the network layer. Switching of lines by the switches L2 and L3 allows the network to have a three-layer configuration in which the side of the server 101 is an upper side, and the side of the client terminals 102 is a lower side. In the example illustrated in FIG. 9, the band of the line of the top layer is 1 G bits per second (bps). The band of the line at a middle layer on the side of the subnets A, B, and C is 1 Gbps. The band of the line at the middle layer on the side of the subnets D and E is 100 Mbps. The bands of all the lines at the bottom layer are each 100 Mbps.

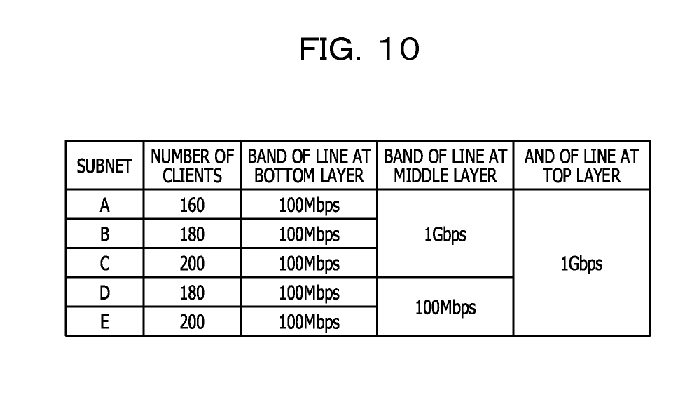

In the case of a network configuration as illustrated in FIG. 9, a network configuration table, for example, as illustrated in FIG. 10 is prepared in advance.

Next, at S12, the setting unit 12 sets the line at the top layer as a line to be processed. Next, at S14, the setting unit 12 determines whether the line to be processed is a line at the bottom layer. If the line to be processed is a line at the bottom layer, the process proceeds to S26. If not, the process proceeds to S16.

At S16, the setting unit 12 determines whether the band of the line to be processed is smaller than the total of bands of lines at a layer immediately lower than the layer of the line to be processed. If so, the process proceeds to S18 where the setting unit 12 proportionally distributes the band of the line to be processed to the bands of lines at the immediately lower layer. In the example of the network configuration table of FIG. 10, the band (1 Gbps) of the line at the top layer is smaller than the total (1 Gbps+100 Mbps) of bands of the lines at the middle layer, which is the immediately lower layer. The setting unit 12 therefore distributes 1 Gbps in a ratio of 1 Gbps:100 Mbps to lines at the middle layer.

Next, at S20, the setting unit 12 determines whether the aforementioned processing at S16 and S18 has been completed for all the lines at the same layer as the line to be processed. If a line that has not been processed exists at the same layer, the process proceeds to S22. Then, the setting unit 12 sets a line that has not been processed and that exists at the same layer, as a line to be processed, and the process returns to S16. Otherwise, if the aforementioned processing at S16 and S18 has been completed for all the lines at the same layer as the line to be processed, the process proceeds to S24. Then, one of the lines at the immediately lower layer is set as a line to be processed, and the process returns to S14.

If, at S18, when a line at the immediately upper layer has been processed as a line to be processed, the band of that line has been proportionally distributed, the band after the proportional distribution is used as the band of a line to be processed. If the band has not been proportionally distributed, the band described in the network configuration table is used.

At S26, the setting unit 12 sets the bands of all the lines at the bottom layer determined at S10 to S24 as the bands of the respective subnets.

Next, at S28, for every subnet, the setting unit 12 calculates a download time per client terminal in the subnet. The download time is a period of time used for downloading that is theoretically determined from the network configuration and the size of an applet to be downloaded. To calculate the download time, first, the band per client terminal is determined as expressed by formula (1) given below.

Band per client terminal=the band of a subnet/the number of client terminals belonging to the subnet (1)

Then, a transmission time and a transmission delay are determined as expressed by formula (2) and formula (3) given below.

Transmission time=the size of an applet/the band per client terminal (2)

Transmission delay=the size of an applet/reception window sizexRTT (3)

Here, the RTT (round trip time) is a period of time taken for a packet to make a round trip between the client terminal 102 and the information processing unit 10. The RTT may be measured, for example, by a packet internet groper (PING).

Then, the setting unit 12 calculates the sum of the transmission time and the transmission delay as a download time. The download time is calculated for every subnet.

Next, at S30, based on the download time calculated for every subnet and a target time set in advance, the setting unit 12 calculates a simultaneous download number threshold value for every subnet, for example, as expressed by formula (4) given below.

The simultaneous download number threshold value=the number of client terminals belonging to the subnetxthe target time/the download time (4)

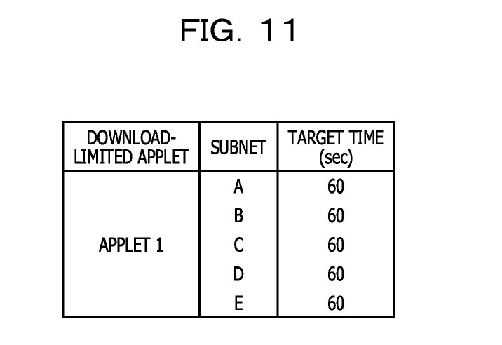

The simultaneous download number threshold value is a threshold value of the number of client terminals indicating that, when a plurality of client terminals in a subnet simultaneously perform download processing of the applet concerned, how many client terminals may simultaneously perform the downloading of the applet concerned in order to complete downloading within the target time. The target time is preferably set in advance for every applet and for every subnet in accordance with the purposes, such as a period of time until the start of operations. The target time is, for example, set in a target time management table as illustrated in FIG. 11.

Next, at S32, the setting unit 12 proportionally distributes the total of simultaneous download number threshold values, which are set for respective subnets, for all the subnets to the subnets within a range where the number of processes determined based on the amount of physical resources of a memory and so forth of the information processing device 10 is not exceeded. The proportionally distributed value is regarded as the initial value of the simultaneous download maximum number for every subnet. In other words, an initial value MAX (x) of the simultaneous download maximum number of a subnet (x) may be calculated as expressed by formula (5) given below.

MAX(x)=α×[(x)−MAX]/Σ([(x)−MAX] of all subnets) (5)

Here, [(x)−MAX] is a simultaneous download number threshold value of the subnet (x), and a is a limiting value of the number of processes determined based on the amount of physical resources of a memory and so forth of the information processing device 10.

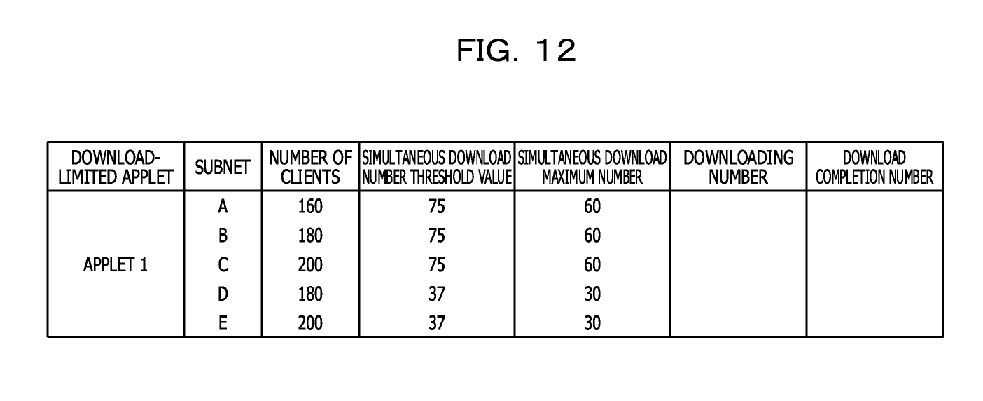

Next, at S34, the setting unit 12 sets the calculated initial value of the simultaneous download maximum number for every subnet in a download management table, for example, as illustrated in FIG. 12. In the download management table, columns for recording the number of client terminals during downloading (hereinafter referred to as a “downloading number”) and the download completion number, which are to be used for processes described later, are also provided. The simultaneous download number threshold value calculated at S30 described above is also set in the download management table.

In the aforementioned setting process routine, the above description has focused on one download-limited applet. If, in contrast, there are a plurality of download-limited applets to be processed in the information processing device 10, the aforementioned setting process may be performed for each download-limited applet. In this case, a in the above formula (5) is set for every applet such that al is set for an applet 1, α2 is set for an applet 2, . . . . In this case, α=α1+a2+ . . . .

In the example of FIG. 9, for the sake of explanatory simplicity, it is assumed for the side of the server 101 that the information processing device 10 occupies the band. In the case of considering other devices in the server 101, the band distributed to the information processing device 10 may be used as the bands of lines at the top layer. In the example of FIG. 9, the bands of all the client terminals 102 in each subnet are assumed to be the same. However, these bands may be bands different from one another. In this case, the band per client terminal in formula (1) may be obtained by proportionally distributing the bands of lines at the bottom layer.

Next, at S40 of the determination process routine illustrated in FIG. 13, the determination unit 14 receives an applet request sent from the client terminal 102. Next, at S42, the determination unit 14 determines whether a download date and time at which the applet concerned has been downloaded to the client terminal 102 is added, for example, as illustrated in FIG. 4, to the received applet request. If the download date and time is added, the process proceeds to S44. If the download data and time is not added, the process proceeds to S54.

At S44, the determination unit 14 determines whether an applet for which the download request has been provided is updated by comparing the download date and time added to the applet request with the update date and time of an applet stored in the content DB 20. If the applet is updated, the process proceeds to S46. If the applet is not updated, the process proceeds to S56.

At S46, the determination unit 14 determines whether the applet for which the download request has been provided is a download-limited applet determined in advance. If the applet is a download-limited applet, the process proceeds to S48. If the applet is not a download-limited applet, the process proceeds to S54.

At S48, the determination unit 14 acquires a simultaneous download maximum number set for a subnet to which the client terminal 102 that has sent an applet request belongs and for the applet for which the download request has been provided, from a download management table, for example, as illustrated in FIG. 12. The determination unit 14 acquires the downloading number for the applet for which the download request has been provided, from the download management table. The downloading number is the number of other client terminals 102 that belong to the same subnet as a subnet to which the client terminal 102 that has sent the applet request belongs, and that are currently downloading the applet for which the download request has been provided. Then, the determination unit 14 determines whether the downloading number is less than the simultaneous download maximum number. If the downloading number<the simultaneous download maximum number, the process proceeds to S50. If the downloading numberahe simultaneous download maximum number, the process proceeds to S56.

Next, at S50, the determination unit 14 increments the downloading number in the download management table corresponding to the applet concerned and the subnet concerned by one. Next, at S52, the determination unit 14 starts to measure the download time of the applet. Next, at S54, the determination unit 14 acquires the applet for which the download request has been provided, from the content DB 20. Then, the determination unit 14 transfers the acquired applet to the client terminal 102 that has sent the applet request. In contrast, at S56, the determination unit 14 provides a response to the effect that the applet will not be transferred, to the client terminal 102 that has sent the applet request, and completes the determination process routine.

Next, at S60 of the adjustment process routine illustrated in FIG. 14, the adjustment unit 16 determines whether the applet transferred at S54 of the determination process is a download-limited applet. If the applet is a download-limited applet, the process proceeds to S62. If the applet is not a download-limited applet, the process proceeds to S88.

At S62, the adjustment unit 16 checks that downloading of the transferred applet to the client terminal 102 has been completed, and completes measurement of the download time. Next, at S64, the adjustment unit 16 decrements the downloading number in the download management table corresponding to the applet concerned and the subnet concerned by one, and increments the download completion number by one. The download completion number is the number of completions of applet downloading for every download-limited applet and for every subnet.

Next, at S66, the adjustment unit 16 calculates a period of time from the start to the completion of measurement of a download time, that is, a period of time used for downloading the applet from the information processing device 10 to the client terminal 102 (hereinafter referred to as a “used time”). Then, the adjustment unit 16 determines whether the used time exceeds a target time for the applet concerned and in the subnet concerned set in the target time management table. If the used time>the target time, then, at S68, the adjustment unit 16 increments the number of times the threshold is exceeded, by one, and the process proceeds to S70. If the used timethe target time, the process skips S68 and proceeds to S70.

At S70, the adjustment unit 16 determines whether a timing for adjusting the simultaneous download maximum number has been reached. It is assumed that the timing for adjusting the simultaneous download maximum number is a timing at which it is possible to determine that the band is narrowed because of downloading of an applet. For example, a timing at which the used time>the target time may be the adjustment timing. However, if the adjustment timing is a timing at which the used time>the target time, the simultaneous download maximum number will be excessively adjusted. To address this, here, when the download completion number for the applet concerned and for the subnet concerned managed in the download management table has reached the simultaneous download maximum number for the corresponding applet and subnet, it is determined that the timing for adjusting the simultaneous download maximum number has been reached. If the timing for adjusting the simultaneous download maximum number has been reached, the process proceeds to S72. If not, the process proceeds to S88.

At S72, the adjustment unit 16 determines whether the number of times the threshold is exceeded is greater than zero. If the number of times the threshold is exceeded>0, the process proceeds to S74. If the number of times the threshold is exceede≦0, the process proceeds to S80.

At S74, the adjustment unit 16 decreases the simultaneous download maximum number for the applet concerned and for the subnet concerned managed in the download management table in a certain proportion (MUL_DL), and records the result in the download management table. MUL_DL is a coefficient less than one. MUL_DL is, for example, 0.5.

Next, at S76, the adjustment unit 16 proportionally distributes the decrease of the simultaneous download maximum number at S74 mentioned above among other subnets in accordance with the current simultaneous download maximum numbers for the applet concerned and for other subnets. That is, the adjustment unit 16 increases the simultaneous download maximum numbers of other subnets. On this occasion, proportional distribution is performed within a range where the simultaneous download maximum numbers of other subnets after the proportional distribution do not exceed their respective simultaneous download number threshold values. Thus, it is possible to adjust the simultaneous download maximum number of each subnet, making maximum use of a limiting value (α) of the number of processes determined based on the amount of physical resources of a memory and so forth of the information processing device 10. The adjustment unit 16 also records the decreases of the simultaneous download maximum numbers of other subnets in the download management table.

Next, at S78, the adjustment unit 16 resets the number of times the threshold is exceeded for the applet concerned and for the subnet concerned, to zero, and the process proceeds to S88.

In contrast, at S80, the adjustment unit 16 increases the simultaneous download maximum number for the applet concerned and for the subnet concerned managed in the download management table by a certain number (INC_DL), and records the result in the download management table. INC_DL is, for example, two. On this occasion, the adjustment unit 16 increases the simultaneous download maximum number for the applet concerned and for the subnet concerned within a range where the simultaneous download maximum number after the increase does not exceed the initial value of the simultaneous download maximum number for the applet concerned and for the subnet concerned. The initial value of the simultaneous download maximum number is calculated using a limiting value (α) of the number of processes determined based on the amount of physical resources of the information processing device 10. Therefore, if a value exceeding the initial value is set, there is a possibility that the capacity of the information processing device 10 might be exceeded.

Next, at S82, the adjustment unit 16 proportionally distributes the increase of the simultaneous download maximum number at S80 mentioned above among other subnets in accordance with the current simultaneous download maximum numbers for the applet concerned and for other subnets. That is, the adjustment unit 16 decreases the simultaneous download maximum numbers of other subnets. The adjustment unit 16 also records the decreases of the simultaneous download maximum numbers of other subnets in the download management table.

At S88, the adjustment unit 16 calculates the download residual number for every subnet by subtracting the download completion number of each subnet for the applet concerned managed in the download management table from the number of client terminals belonging to the corresponding subnet. Then, the adjustment unit 16 determines whether the calculated download residual number is smaller than the simultaneous download maximum number, for the applet concerned and for every subnet. For a subnet for which the simultaneous download maximum number>the download residual number, the process proceeds to S90. Then, the adjustment unit 16 changes the simultaneous download maximum number to the download residual number.

Next, at S92, the adjustment unit 16 proportionally distributes the decrease of the simultaneous download maximum number resulting from the change at S90 mentioned above among other subnets in accordance with the current simultaneous download maximum numbers for the applet concerned and for other subnets. That is, the adjustment unit 16 increases the simultaneous download maximum numbers of other subnets. On this occasion, proportional distribution is performed within a range where the simultaneous download maximum numbers of other subnets after the proportional distribution do not exceed their respective simultaneous download number threshold values. The adjustment unit 16 also records the increases of the simultaneous download maximum numbers of other subnets in the download management table, and completes the adjustment process routine.

Here, the case where download control for every subnet is not performed is referred to as a comparative example, and an example in which the comparative example is compared with download control in this embodiment will be described. Both in the comparative example and in this embodiment, it is assumed that the network configuration illustrated in FIG. 9 and FIG. 10 is used, the size of a download-limited applet is 10 MB, the target time is 60 seconds (common to all the subnets), INC_DL=20, MUL_DL=0.5, and a=240.

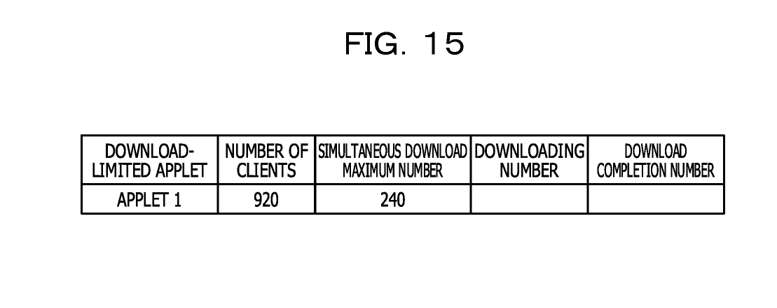

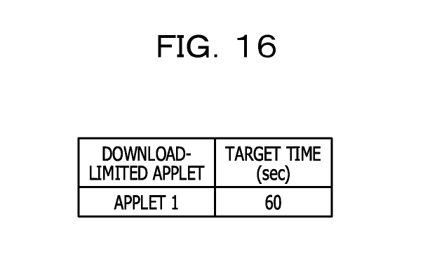

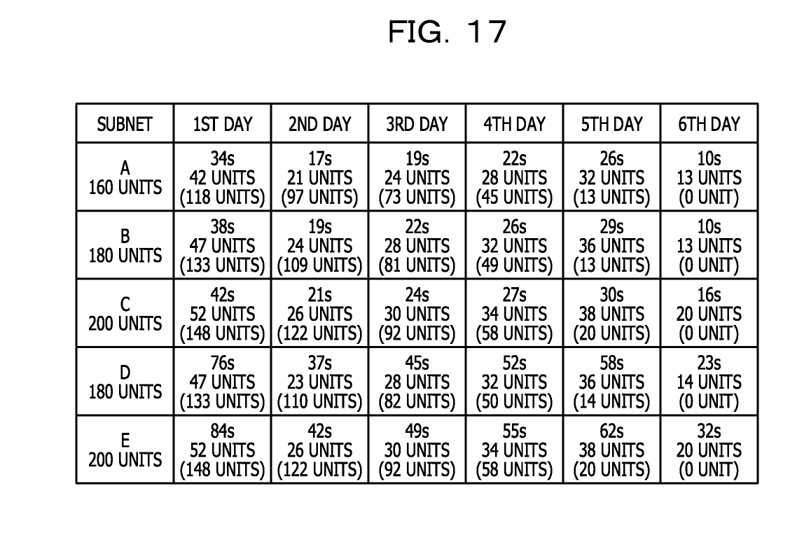

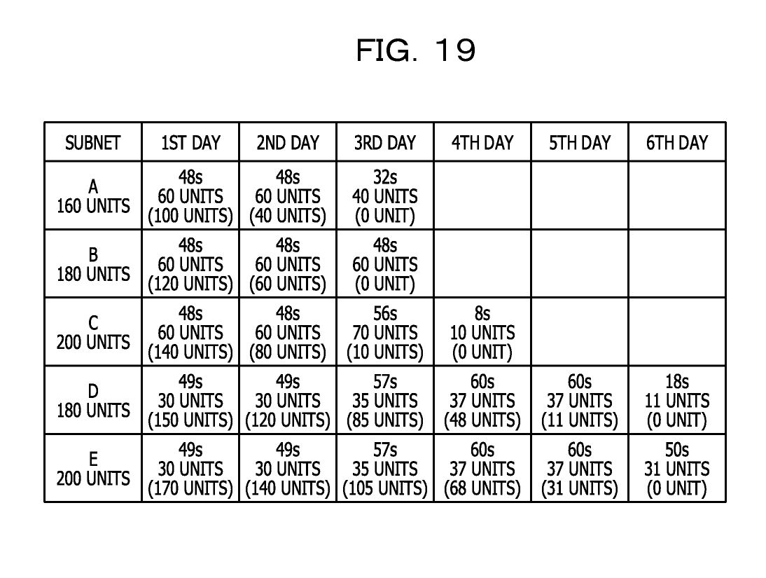

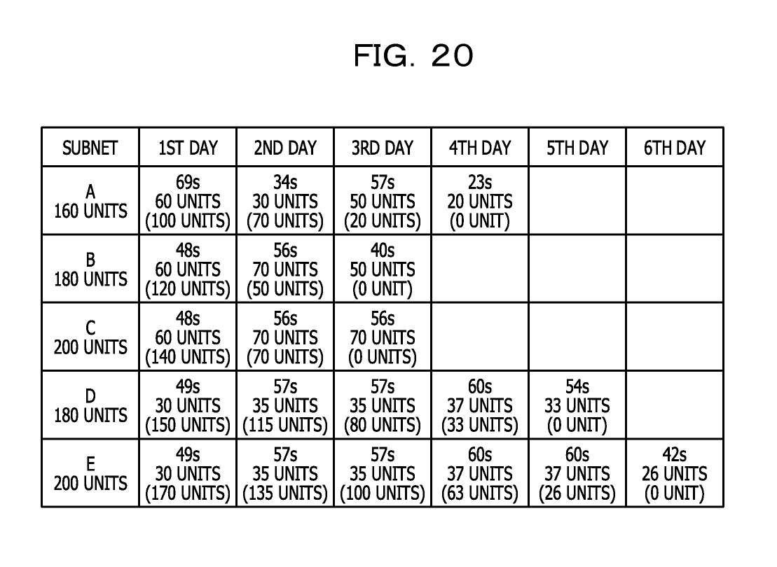

In the comparative example, the simultaneous download maximum number in the entire network is 240. For the comparative example, FIG. 15 depicts a download management table, and FIG. 16 depicts a target time management table. FIG. 17 illustrates download results of an applet for every subnet. Each column of FIG. 17 illustrates download results in each day. The first step of each box is the time used for downloading. The second step is the number of client terminals that have completed download processing. The third step is the download residual number. The same applies to FIG. 19 and FIG. 20 referred to later.

In the comparative example, if there is even one subnet in which the time used for downloading exceeds the target time, the simultaneous download maximum number of the entire network is adjusted (decreased) in a proportion of MUL_DL. As illustrated in FIG. 17, for any subnet, six days are used until all the client terminals belonging to the subnet complete downloading of the applet. In each of the subnet D (76 seconds) and the subnet E (84 seconds) in the first day and the subnet E (62 seconds) in the fifth day, the time used exceeds the target time.

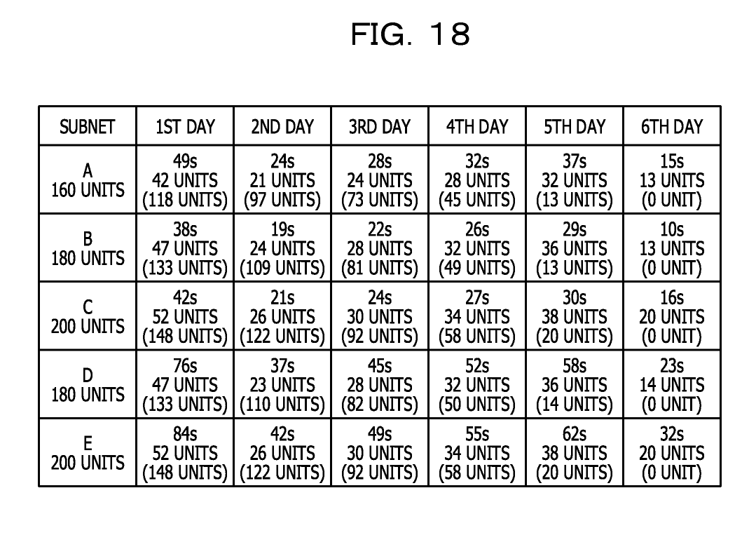

Additionally, FIG. 18 illustrates download results in the comparative example in the case where the band usable for the subnet A in the time zone for applet downloading (for example, upon start of operations) is affected by another application or the like, and is thereby decreased to 70% of the original band. As compared with the case of FIG. 17, the time used for downloading of the subnet A is longer in each day.

Next, the download results in this embodiment are illustrated in FIG. 19. In the example of this embodiment, the simultaneous download number threshold value of each of the subnets A, B, and C is 75, and the simultaneous download number threshold value of each of the subnets D and E is 37. The download management table is depicted in FIG. 12, and the target time management table is depicted in FIG. 11. As illustrated in FIG. 19, three days are used for completion of downloading for each of the subnets A and B, and four days are used for completion of downloading for the subnet C. The adjustment unit 16 adjusts the simultaneous download maximum number for every subnet, and distributes the increase or decrease to other subnets. Therefore, in all the subnets, the used time does not exceed the target time.

Additionally, FIG. 20 illustrates download results in this embodiment, as in the above comparative example, in the case where the band usable for the subnet A in the time zone for applet downloading (for example, upon start of operations) is affected by another application or the like, and is thereby decreased to 70% of the original band. As compared with the case of FIG. 19, the time used for downloading of the subnet A in the first day exceeds the target time. However, it is found that, owing to download control after that, downloading over the entire network is efficiently performed as compared with the comparative example.

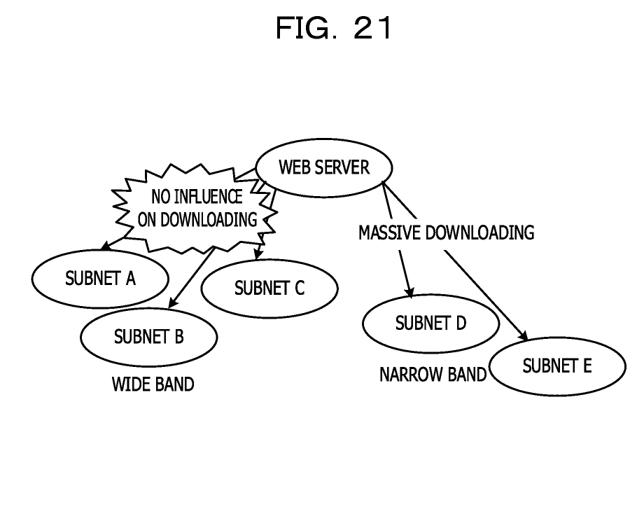

As described above, with the information processing device 10 according to this embodiment, the simultaneous download maximum number is adjusted for every applet and for every subnet. Thus, as illustrated in FIG. 21, if a large amount of downloading is performed from a subnet having a narrow band, it is possible to avoid a situation in which the influence of the large amount of downloading is exerted on downloading for another subnet having a sufficient band. As a result, suppression of network loads is equalized among subnets. Accordingly, efficient download control may be achieved over the entire network.

The initial value of the simultaneous download maximum number is calculated using a limiting value (α) of the number of processes determined based on the amount of physical resources of the information processing device 10. Thus, it is possible to make maximum use of the amount of physical resources of the information processing device 10.

The increase or decrease in the simultaneous download maximum number of some subnet is distributed to other subnets in consideration of the initial value of the simultaneous download maximum number, or the simultaneous download number threshold value. Thus, it is possible to make maximum use of the amount of physical resources of the information processing device 10 and to achieve efficient download control while maintaining the target time for downloading in each subnet.

Additionally, if the download residual number for every applet and for every subnet is smaller than the simultaneous download maximum number, the simultaneous download maximum number is changed to the download residual number, and the decrease resulting from the change is distributed to other subnets. Thus, more efficient download control may be performed.

In the foregoing, the case where the target content of download control is an applet has been described; however, this is not limitative. The techniques of this disclosure may be applied to various kinds of content such as programs and various types of data. Nonetheless, it is more effective to apply the techniques of this disclosure to content that is not urgent in terms of being updated, such as an applet that is likely to be simultaneously downloaded to a plurality of client terminals and for which the same content that has been cached is usable.

In the foregoing, the manner in which the information processing program 50, which is an example of the information processing program in the techniques of this disclosure, is stored (installed) in advance in the storage unit has been described. However, the information processing program in the techniques of this disclosure may also be provided in a form in which the program is recorded on a recording medium such as a compact disc read-only memory (CD-ROM) or a digital video disc (DVD)-ROM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing method performed by a computer coupled to a plurality of terminal devices belonging to a network divided into a plurality of subnets including at least a first subnet and a second subnet, the plurality of terminal devices including at least a first terminal device belonging to the first subnet and a second terminal device belonging to the second subnet, the information processing method comprising:
setting a first number in association with the first subnet and a second number in association with the second subnet, the first number representing the number of terminal devices capable of simultaneously performing download processing of certain content, among one or more terminal devices belonging to the first subnet, and the second number representing the number of terminal devices capable of simultaneously performing download processing of the certain content, among one or more terminal devices belonging to the second subnet;
receiving a download request from the first terminal device;
downloading target content indicated in the download request to the first terminal device, when the number of terminal devices belonging to the first subnet that are performing download processing of the target content is less than the first number;
measuring a time used for downloading related to the downloading of the target content to the first terminal device; and
updating the first number and the second number, based on a comparison of the time measured by the measuring and a predetermined time.

2. The information processing method according to claim 1, further comprising:
notifying the first terminal device that downloading to the first terminal device is not to be performed, when the number of terminal devices belonging to the first subnet that are performing download processing of the target content is equal to or greater than the first number.

3. The information processing method according to claim 1, wherein the updating includes:
decreasing the first number and updating the second number based on a number by which the first number is decreased, when the time measured by the measuring exceeds the predetermined time; and
increasing the first number and updating the second number based on a number by which the first number is increased, when the time measured by the measuring does not exceed the predetermined time.

4. The information processing device according to claim 3, wherein updating of the second number includes:
determining the second number by proportional distribution, based on a difference between before and after a change of the first number.

5. The information processing method according to claim 1, wherein the setting includes:
determining a band per terminal device by dividing a band of a subnet by the number of terminal devices belonging to the subnet, for each of the plurality of subnets;
determining a download time including a transmission delay time between the information processing device and a terminal device, for each of the plurality of subnets, based on the band per terminal device and a size of the certain content;
determining a threshold value indicating the number of the terminal devices capable of simultaneously performing download processing within the target period of time, for each of the plurality of subnets, by dividing a product of the number of terminal devices belonging to the subnet and a target period of time set in advance for the subnet by the download time; and
determining the first number and the second number by proportionally distributing a total of the threshold value calculated for each of the plurality of subnets to the plurality of subnets.

6. The information processing method according to claim 1, further comprising:
comparing a residual number representing the number of terminal devices that belong to the first subnet and that have not completed the download processing, and the updated first number, and
changing the updated first number to the residual number when the residual number is smaller than the updated first number.

7. The information processing method according to claim 6, further comprising:
updating the updated second number, based on a difference between before and after a change of the updated first number.

8. The information processing method according to claim 1, further comprising:
referring to version information of the target content included in the download request, and notifying the first terminal device that downloading to the first terminal device is not to be performed, when it is determined that the first terminal device has the target content of a latest version.

9. The information processing method according to claim 1,
wherein the computer is configured to execute the download processing based on a number of terminal devices capable of simultaneously performing the download processing, among the plurality of terminal devices belonging to the network.

10. The information processing method according to claim 1,
wherein the first subnet and the second subnet respectively coupled to the computer.

11. An information processing device coupled to a plurality of terminal devices belonging to a network divided into a plurality of subnets including at least a first subnet and a second subnet, the plurality of terminal devices including at least a first terminal device belonging to the first subnet and a second terminal device belonging to the second subnet, the information processing device comprising:
a memory, and
a processor coupled to the memory and configured to:
set a first number in association with the first subnet and a second number in association with the second subnet, the first number representing the number of terminal devices capable of simultaneously performing download processing of certain content, among one or more terminal devices belonging to the first subnet, and the second number representing the number of terminal devices capable of simultaneously performing download processing of the certain content, among one or more terminal devices belonging to the second subnet;
receive a download request from the first terminal device;
download target content indicated in the download request to the first terminal device, when the number of terminal devices belonging to the first subnet that are performing download processing of the target content is less than the first number;
measure a time used for downloading related to the downloading of the target content to the first terminal device; and
update the first number and the second number, based on a comparison of the time measured by the measuring and a predetermined time.

12. The information processing device according to claim 11, wherein the processor is further configured to:
notify the first terminal device that downloading to the first terminal device is not to be performed, when the number of terminal devices belonging to the first subnet that are performing download processing of the target content indicated in the download request is equal to or greater than the first number.

13. The information processing device according to claim 11, wherein the processor is configured to:
decrease the first number and updating the second number based on a number by which the first number is decreased, when the time used for downloading exceeds the predetermined time; and
increase the first number and updating the second number based on a number by which the first number is increased, when the time used for downloading does not exceed the predetermined time.

14. A non-transitory computer-readable storage medium storing a program causing a computer coupled to a plurality of terminal devices belonging to a network divided into a plurality of subnets including at least a first subnet and a second subnet to execute a process, the plurality of terminal devices including at least a first terminal device belonging to the first subnet and a second terminal device belonging to the second subnet, the process comprising:
setting a first number in association with the first subnet and a second number in association with the second subnet, the first number representing the number of terminal devices capable of simultaneously performing download processing of certain content, among one or more terminal devices belonging to the first subnet, and the second number representing the number of terminal devices capable of simultaneously performing download processing of the certain content, among one or more terminal devices belonging to the second subnet;
receiving a download request from the first terminal device;
downloading the target content to the first terminal device, based on the download request, when the number of terminal devices belonging to the first subnet that are performing download processing of target content indicated in the download request is less than the first number;
measuring a time used for downloading related to the downloading of the target content to the first terminal device; and
updating the first number and the second number, based on a comparison of the time used and a predetermined time.
